(19) United States
(12) Patent Application Publication
(10) Pub. No.: US 2022/0405538 A1
(43) Pub. Date: Dec. 22, 2022

(54) COLOR CORRECTION

(71) Applicant: Hewlett-Packard Development Company, L.P., Spring, TX (US)

(72) Inventors: Noam Shaham, Nes Ziona (IL); Eddi Litvak, Nes Ziona (IL)

(73) Assignee: Hewlett-Packard Development Company, L.P., Spring, TX (US)

(21) Appl. No.: 17/777,439

(22) PCT Filed: Dec. 20, 2019
(86) PCT No.: PCT/US2019/067811

§ 371 Date: May 17, 2022

(51) Int. Cl. G06K 15/02

(52) U.S. Cl. CPC G06K 15/1878; G06K 15/1822

(57) ABSTRACT

In an example, a method comprises: for each of a plurality of areas of a target image, determining a color vector representing that area, wherein the color vector is defined in a color space. The method may further comprise producing a color histogram of the target image by associating each area of the target image with a histogram bin representing a particular color, based on the determined color vector of the area; defining a color represented by a histogram bin associated with a highest number of image areas as a dominant color of the target image; and applying a correction to a print version of the target image for an area that is intended to have the dominant color.

### BACKGROUND

Printed colors in an image may not exactly match target colors specified in a proof version of the image or a digital target image, for example due to printer specific variations. In order to print colors with a high level of accuracy (for e.g. brand colors, emulated spot colors etc.) corrections may therefore be applied so that printed colors more closely resemble target colors.

### BRIEF DESCRIPTION OF THE DRAWINGS

Non-limiting examples will now be described with reference to the accompanying drawings, in which:

FIG. 1 shows a schematic representation of an example method, which may be a method for correcting colors in an image for printing;

FIG. 2 shows a schematic representation of an example color space, which may be used in the method of FIG. 1;

FIG. 3 shows a schematic representation of an example printing apparatus;

FIG. 4 shows a schematic representation of another example printing apparatus;

FIG. 5 shows a schematic representation of an example machine-readable medium in association with a processor.

### DETAILED DESCRIPTION

Colors may be produced in a printed image using a set of process colors such as Cyan, Magenta, Yellow and Black (CMYK), Cyan, Magenta, Yellow, Black, Orange, Green and Violet (CMYK-OGV), or another set of colors. The process colors may be combined by printing them on a print target using halftoning techniques to produce a gamut of different colors in a printed image. In order to correct for any variations or inaccuracies in color representation in printed images, global corrections may be applied to the amounts/ratios/coverage levels of the process colors used to provide the colors. However, applying global corrections to the process colors may improve the accuracy of representation of one color in the image but may cause another color in the image to drift further away from its target. Therefore, it can be useful to apply corrections separately to each color represented in the image.

High color accuracy may be particularly of interest for dominant colors in an image. For example, if an image includes a small number of pixels with a particular color, the color accuracy of those pixels may be lower priority than a color which is present in a large number of pixels in the image. Examples described herein may therefore automatically detect dominant colour(s) in an image so that color specific corrections can be applied to the dominant colors in particular, to ensure their accuracy. Dominant colors in an image may be more likely to represent e.g. brand colors, for which a higher level of accuracy is often wanted by a user of a printing system. The method described herein may ensure the color accuracy of an image meets the expectations of a user, without the user having to provide extra information such as defining certain colors as spot colors or explicitly specifying for which areas of the image a higher color accuracy is wanted.

Color can be represented within imaging devices such as print and display devices in a variety of ways. For example, in one case, a color as observed visually by an observer is defined with reference to a power or intensity spectrum of electromagnetic radiation across a range of visible wavelengths. In other cases, a color model is used to represent a color at a lower dimensionality. For example, certain color models make use of the fact that color may be seen as a subjective phenomenon, i.e. dependent on the make-up of the human eye and brain. In this case, a “color” may be defined as a category that is used to denote similar visual perceptions; two colors are said to be similar if they produce a similar effect on a group of one or more people.

Within this context, a color model may define a color space. A color space in this sense may be defined as a multi-dimensional space, with a point in the multi-dimensional space representing a color value and dimensions of the space representing variables within the color model. Color spaces may include, for example, an RGB color space or an L*a*b* color space. A color space can also be based on a set of process colors within a printing apparatus. For example, a Cyan, Magenta, Yellow and Black (CMYK) color space, in which four variables representing four process colors are used in a subtractive color model to represent different quantities of colorant. For example, the color space may be defined by a set of orthogonal axes, each defining an amount or coverage level (per area) of a different process color, such that each point in the color space effectively represents a recipe of the amount of each process color needed to represent the color located at that point in the color space. In some examples a color space may be based on a HSL (hue, saturation, lightness) or a HSV (hue, saturation, value) color model, wherein a vector defined in the color space has a property that represents a hue.

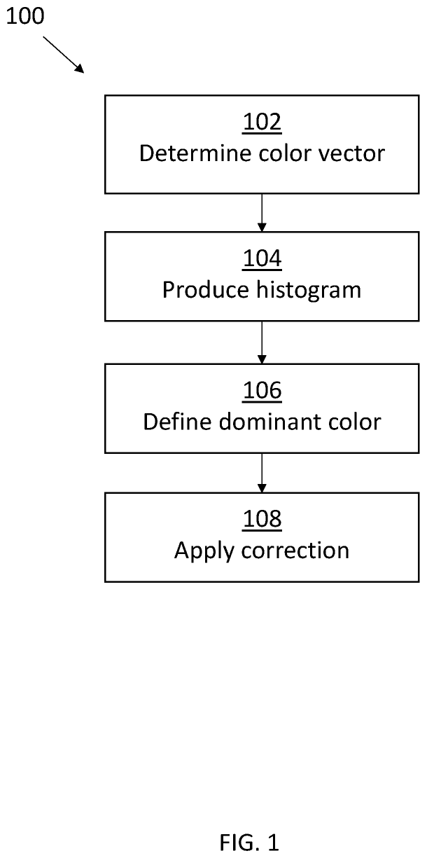

FIG. 1 shows a method 100, which may be a method of correcting colors in an image for printing. Each block of method 100 may be performed by a printing apparatus such as the printing apparatus 300 shown in FIG. 3. The method 100 comprises, at block 102, for each of a plurality of areas of a target image, determining a color vector representing that area, wherein the color vector is defined in a color space based on a set of process colors for producing a print version of the target image

Each point in the color space represents an amount of each of the process colors. A corresponding vector can be defined for each point in the color space as a line, from an origin of the color space (representing a white point) to the point. For example, a color vector for representing a first color having a particular grayscale level defined in CMYK color space may be defined as Sₐ=(CMYK)=(1, 0.32, 0, 0.14) All point sitting along the same line from the origin as the color vector will have the same ratio of process colors and therefore will represent different grayscale levels (or tints) of the same color. For example, a color vector defined in CMYK color space as (0.5, 0.16, 0, 0.07) would represent a lighter tint of the first color defined above, as it has the same direction but a shorter length.

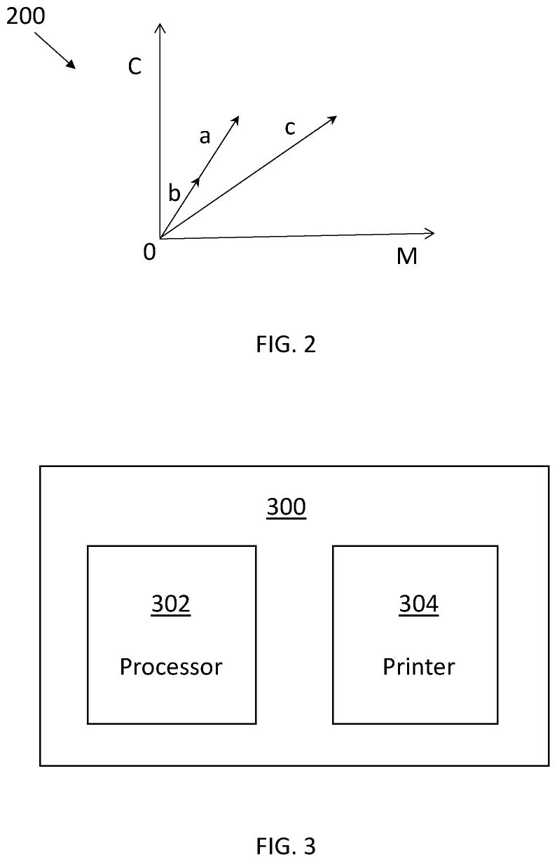

FIG. 2 shows a schematic representation of an example colour space 200 that may be used in block 102 of FIG. 1. In the example of FIG. 2, the y-axis of the color space 200 represents an amount or coverage level of the process color cyan and the x-axis represents an amount or coverage level of the process color magenta. The color space may also comprise other orthogonal axes (not shown) representing further process colors such that each color and shade or tint that can be produced by the set of process colors can be represented as particular point in the color space 200. A vector from the origin (in this case representing a white point of the color space 200) can be defined for each point in the color space as explained above. In this case vector a represents a color vector of a first color and vector b represents a different tint of the same ratio of process colors but with a different tint as these vectors have the same direction. Vector c represents a different ratio of process colors as it has a different direction from vectors a and b.

In some examples the target image may be a physical printed proof image that may be scanned, for example by a spectrophotometer to determine a color vector for each area. In some examples, the target image may be a digital image file, from which a color vector may be acquired for each area. In some examples a color vector may be determined for each pixel of the image. The digital image file may be e.g. one or a set of image files received from a raster image processor engine.

Block 104 comprises producing a color histogram of the target image by associating each area of the target image with a histogram bin representing a particular color, based on the determined color vector of the area. That is, each histogram bin may represent a different color vector. In some examples, different grayscale levels of the same color may be placed in the same histogram bin, i.e. each histogram bin is associated with a set of color vectors all having a same direction or angle in the color space. In some examples substantially similar color vector directions (i.e. with small angles between them) may be represented by a single histogram bin, for example where these color vectors would be perceived by a viewer as the same or substantially the same color.

In some examples, the color vectors may be defined in, or converted to a color space that is not based on process colors, prior to histogram creation. For example, the target image data may be received in process color space and then converted from process color space to a different color space prior to defining the vectors and creating the histogram. For example, in a HSL (hue, saturation, lightness) or HSV (hue, saturation, value) color space. In that case, the hue scalar of the color vector represents a particular hue and image areas may be sorted into histogram bins based on the hue of that area. This can provide improved performance when certain color transformations such as gray level replacement color profile are applied to the job. In some examples, the target image may be received (e.g. from a RIP engine) with the color of each pixel defined in process color space, and the method 100 may include, at block 102, converting color data of the target image to a different color space prior to determining the color vectors. The different color space may be a color space that represents hue as a direction of a color vector defined in that space or in a particular plane of that space e.g. HSL or HSV.

Block 106 comprises defining a dominant color represented by a histogram bin associated with a highest number of image areas as a dominant color of the target image. The histogram bins may be ranked by how populated they are (e.g. how many pixels of that color are present in the target image). The color represented by the most populated bin may then be defined as a dominant color of the image.

In some examples, the color represented by the second most populated bin may also be defined as a dominant color of the image. I.e. block 106 may also comprise comprising defining a histogram bin associated with a second highest number of image areas as a second dominant color of the target image and applying a correction to the print version of the target image for an area that corresponds to an area in the target image having the second dominant color. The correction applied to the dominant color area may be different from the correction applied to the second dominant color area. That is, using the method 100 of FIG. 1, color specific corrections can be selectively applied to different colors in the image.

In some examples, a plurality of colors of the target image may be defined as dominant colors based on the absolute or relative numbers of pixels or otherwise defined image areas that have been sorted into the histogram bins representing these colors. In some examples all of the colors in a target image may be defined as dominant colors. In some examples, a color may be defined as a dominant color if a histogram bin representing that color has an associated number of image areas that is higher than a threshold number. In other examples, a predetermined number of the most highly populated bins may each be determined to represent a dominant color (for example the five or ten most populated histogram bins).

Block 108 of method 100 comprises applying a correction to the print version of the target image for an area that is intended to have the dominant color. Block 108 may comprise applying a correction to all areas of the print version of the target image that are intended to have the dominant color. In some examples, the areas that are intended to have the dominant color may be determined by determining which areas of the print version of the image have a location that corresponds to an area in the target image having the dominant color.

The method 100 may therefore enable a correction or retouch of dominant colors in an image without affecting other colors in the image and without needing to re-rasterize the image. The method may also enable control over all dominant colors in a job and not just those that have been predefined as e.g. spot colors. The method 100 may enable fast or real-time color correction and more efficient use of processor resources, as color correction can be prioritized for the dominant colors of an image rather than correcting all colors of the image.

In some examples, a color correction may comprise adjusting an amount or a ratio of process colors used to produce the color to be corrected. In some examples, the correction may be applied specifically to colors previously defined as dominant colors.

In some examples, where a plurality of dominant colors have been identified in the target image, an applied correction for a particular area of the image to be printed may depend on which dominant color that area is intended to have. Therefore, color specific corrections can be applied to each color individually.

In some examples, areas that are intended to have the dominant color may be determined by performing a color analysis on the print version of the image prior to printing. The color analysis may comprise determining a color vector for each area of the print version of the image. The print version color vectors may then be used to determine a distance between the print version color vector and a color vector associated with the dominant color. If the distance between these two vectors is below a threshold, the method may comprise determining that the area of the print version of the image is intended to represent the dominant color. If the difference is below the threshold, applying the correction may comprise reducing the difference so as to substantially reproduce the dominant color of the target image in the output of a printing apparatus. In some examples, the difference may be reduced to zero so that the color of the area to be printed exactly matches the dominant color. In some examples, the difference may be reduced, but not to zero, for example to provide smoother blending effects between colors in the image. In some examples the amount of difference reduction applied may be based on the size of the difference, with smaller corrections being applied to colors that have a greater initial distance in color space from the dominant color.

In some examples, the method 100 may comprise converting the print version of the image to a different color space than the printer's process colors for the color analysis and correction and then converting the corrected image data for the print version of the image back to process color space prior to printing.

The print version color vectors may be determined from a file comprising digital print instructions from the image or an emulated image representing how the image will look when printed on a particular printer. In some examples, the print version color vectors may be determined from a previously printed version of the same target image, e.g. using a color measurement device such as a spectrophotometer. In some examples the particular correction to be applied may be selected or defined by a user of a printing apparatus, for example based on visual inspection of a hard copy proof version of a target image. In other examples the correction process may be fully automated. In this way the method 100 can provide a closed loop control over dominant colors in an image for printing.

In some examples, the method may comprise saving corrected color data for future prints of the same target image. In some examples, the method may comprise, after applying the color correction to the image to be printed, re-rasterizing the image to be printed, after applying the new color values to the RIP. Re-rasterizing the image after applying corrections may provide an improved color match if the same job is re-printed later on the same printer.

FIG. 3 shows a printing apparatus 300 which may be suitable to perform the method 100 described above. The printing apparatus 300 comprises a processor 302, wherein the processor 302 is configured to receive a target image defining target colors for an image to be printed. The processor 302 is further to, for each of a plurality of areas of the target image, determine a color vector representing that area, wherein the color vector represents a ratio of process colors of the printing apparatus 300. The processor 302 is then to sort the areas into bins based on their determined color vectors and to define a color represented by a color vector associated with a highest populated bin as a dominant color of the target image. The processor 302 is then to apply a color specific correction to areas of the image to be printed that correspond to areas of the target image that were sorted into the highest populated bin. The color associated with the highest populated bin may be described herein as a dominant color of the target image.

In some examples, the color vector is defined in a color space having a white point at an origin of the color space and wherein each axis of the color space represents a separate one of the process colors of the printing apparatus. In some examples a direction of the color vector from the white point of the color space represents the ratio of process colors of the printing apparatus and a length of the color vector from the white point of the color space represents a coverage level of process inks to be applied to an area having a color represented by the color vector.

In some examples, sorting the areas into bins comprises sorting the areas into bins of a color histogram, with each bin representing a different ratio of process colors. That is, color vectors having a same direction but different length may be sorted into the same bin of the color histogram. In this way, any corrections applied to a particular color will be applied consistently to all grayscale shades of that color, having the same relative ratio of process colors. In some examples, areas may be sorted into histogram bins based on both the direction and length of their associated color vector, such that each histogram bin represents a point in the color space. In this case, color vectors ending at points within a threshold radius of a particular point may be sorted into the same color bin, for example where color points that fall within the threshold radius represent colors that would be perceived by a viewer as the same or substantially the same color.

In some examples, the color vectors may be defined in a different color space. For example, in a HSL (hue, saturation, lightness) or HSV (hue, saturation, value) color space. In that case, a direction of the color vector represents a particular hue and image areas may be sorted into histogram bins based on the hue of that area. This can enable improved performance if a gray level replacement color profile is applied to the job. In some examples, the target image may be received (e.g. from a RIP engine) with the color of each pixel defined in process color space, and the processor 302 may be to convert color data of the target image to a different color space such as HSL or HSV prior to determining the color vectors.

In some examples, the processor 302 is to define a plurality of dominant colors of the target image, wherein the plurality of dominant colors are represented by a plurality of highest populated bins and apply a color correction to each area of the image to be printed that has a color that corresponds to one of the plurality of dominant colors.

In some examples, the processor 302 may be part of a press of the printing apparatus 300, that is, the processor 302 may be located after a digital front end comprising a raster image processor in a workflow of the print apparatus.

The printing apparatus 300 also comprises a printer 304 to print the color corrected image. The printer 304 may be, for example a 2D printing system such as an inkjet or digital offset printer, or a 3D printing system, otherwise known as an additive manufacturing system.

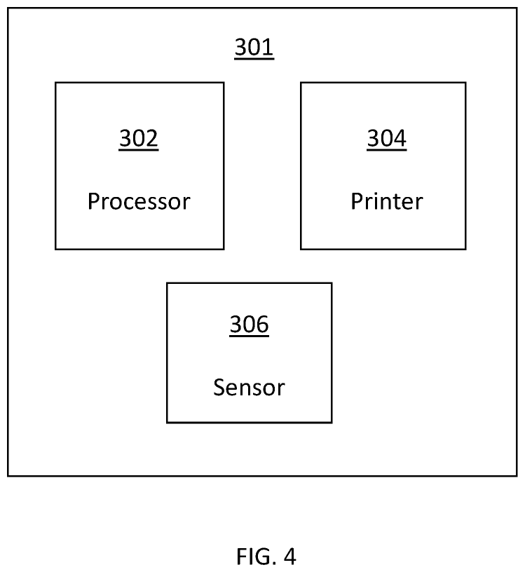

FIG. 4 shows an example apparatus 301, which includes a processor 302 and printer 304 as described above in relation to FIG. 3. The apparatus 301 also includes a sensor 306 for measuring color on a printed page, such as a spectrophotometer. In this case, the processor 302 may cause the printer 304 to print a test area of the dominant color. e.g. where there are a plurality of dominant colors the test area may comprise a bar of color patches of the original and corrected dominant color values, on top of a printed page comprising a print version of the target image, or on a separate different test page. The test area may be printed at a location accessible by the color sensor 306. In some examples, the test area may comprise an uncorrected version of the dominant color. The data from the sensor 306 may then be passed to the processor 302 which may use this data to correct the dominant colors in the image in a closed-loop system. In some examples, the test area may comprise a corrected version of the dominant color. The sensor 306 may then be used to check the accuracy of the correction. In some cases, a further correction may then be applied, or the correction may be applied in an iterative manner. In some examples the test area may include uncorrected and corrected sample areas of the dominant color for measurement by the color sensor 306. In some examples, the test area may comprise a printed area for each dominant color at one or more coverage levels.

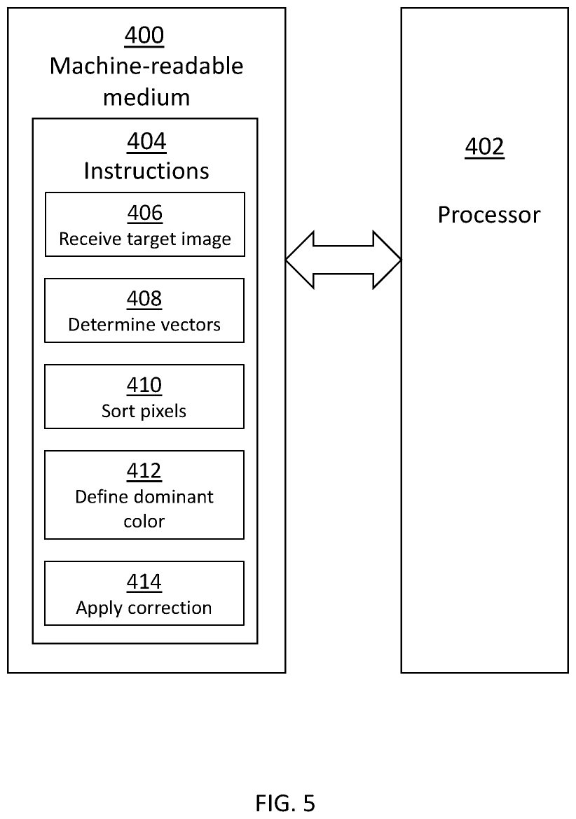

FIG. 5 shows a tangible machine-readable medium 400 in association with a processor 402. The machine-readable medium 400 and processor 402 may form part of a printing apparatus, such as the printing apparatus 300 described above in relation to FIG. 3. The machine-readable medium and processor 402 may be suitable to perform the method 100 of FIG. 1. The machine-readable medium 400 comprises a set of instructions 404 which, when executed by the processor 402, cause the processor 402 to, at block 406, receive a target image defining target colors for an image to be printed. At block 408 the instructions are to cause the processor to, for each pixel of the target image, determine a vector, the vector having a property representing an aspect the color of the pixel as defined in a color space (e.g. one or more color properties such as hue, chroma, lightness, or a ratio of process colors etc.). At block 410 the instructions are to cause the processor to sort the pixels into bins based on their associated vector properties. For example, where the vector property is hue, pixels may be sorted into bins based on their hue. Where the vector property is direction (e.g. representing a ratio of process colors), pixels may be sorted into bins based on the directions of their associated color vectors. At block 412, the instructions are to define a color associated with a highest populated bin as a dominant color of the target image. At block 414, the instructions are to apply a correction to pixels of the image to be printed having a color that corresponds to the dominant color.

In some examples, the instructions 404 may be to define a plurality of dominant colors of the target image based on the most populated bins.

In some examples, the instructions to apply the correction may comprise instructions to compare a color of a pixel in the image to be printed with the dominant color to determine a difference between the color of the pixel to be printed and the dominant color. If the difference is below a predetermined threshold, the instructions may be to determine that the color of the pixel to be printed corresponds to the dominant color, and reduce the difference by adjusting one or a plurality of color values of the pixel to be printed (e.g. by adjusting the amounts, relative ratios or coverage levels of one or a plurality of the process colors).

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

It shall be understood that some blocks in the flow charts can be realized using machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus, functional modules of the apparatus and devices may be implemented by a processor executing machine readable instructions stored in a memory, or a processor operating in accordance with instructions embedded in logic circuitry. The term ‘processor’ is to be interpreted broadly to include a CPU, GPU, processing unit, ASIC, logic unit, or programmable gate array etc. or some combination of these. The methods and functional modules may all be performed by a single processor or divided amongst several processors.

Such machine readable instructions may also be stored in a computer readable storage that can guide the computer or other programmable data processing devices to operate in a specific mode. Further, some teachings herein may be implemented in the form of a computer software product, the computer software product being stored in a storage medium and comprising a plurality of instructions for making a computer device implement the methods recited in the examples of the present disclosure.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
for each of a plurality of areas of a target image, determining a color vector representing that area, wherein the color vector is defined in a color space;
producing a color histogram of the target image by associating each area of the target image with a histogram bin representing a particular color, based on the determined color vector of the area;
defining a color represented by a histogram bin associated with a highest number of image areas as a dominant color of the target image; and
applying a correction to a print version of the target image for an area that is intended to have the dominant color.

2. The method according to claim 1, wherein the color space is defined by a set of orthogonal axes, each representing a process color, and wherein a direction of the color vector represents a particular ratio of process colors and a length of the color vector represents a grayscale level.

3. The method according to claim 1, wherein the color space is a HSL or HSV color space and wherein a vector scalar of the color vector represents a particular hue.

4. The method according to claim 2, wherein color vectors having a same direction but different lengths are sorted into a same histogram bin.

5. The method according to claim 1, further comprising receiving a target image having color data defined in a process color space and converting the color data to a different color space prior to determining the color vectors.

6. The method according to claim 1, further comprising defining a histogram bin associated with a second highest number of image areas as representing a second dominant color of the target image and applying a correction to the print version of the target image for an area that corresponds to an area in the target image having the second dominant color, wherein the correction applied to the dominant color area is different from the correction applied to the second dominant color area.

7. The method according to claim 1, wherein applying the correction comprises: comparing a color to be printed in an area of the print version of the target image with the dominant color to determine a difference between the color to be printed and the dominant color; and
if the difference is below a predetermined threshold, reducing the difference so as to substantially reproduce the dominant color of the target image in the output of a printing apparatus.

8. A printing apparatus comprising:
a processor to:
receive a target image defining target colors for an image to be printed;
for each of a plurality of areas of the target image, determine a color vector representing that area, wherein the color vector is represented in a color space;
sort the areas into bins based on their determined color vectors;
define a color represented by a color vector associated with a highest populated bin as a dominant color of the target image;
apply a color specific correction to areas of the image to be printed that correspond to areas of the target image that were sorted into the highest populated bin; and
a printer to print the color corrected image.

9. The printing apparatus according to claim 8 wherein the color vector is defined in a color space having a white point at an origin of the color space and wherein each axis of the color space represents a separate one of the process colors of the printing apparatus, such that a direction of the color vector from the white point of the color space represents a ratio of process colors of the printing apparatus and a length of the color vector from the white point of the color space represents a coverage level of process inks to be applied to an area having a color represented by the color vector.

10. The printing apparatus according to claim 8 wherein a property of the color vector represents a particular hue and sorting the areas into bins comprises sorting the areas into bins of a color histogram, based on their hue.

11. The printing apparatus according to claim 8 wherein the processor is to:
define a plurality of dominant colors of the target image, wherein the plurality of dominant colors are represented by a plurality of highest populated bins; and
apply a color correction to each area of the image to be printed that has a color that corresponds to one of the plurality of dominant colors.

12. The printing apparatus according to claim 8, wherein the apparatus further comprises a color sensor;
wherein the processor is to cause the printer to print a test area representing the dominant color;
wherein the color sensor is to measure color data of the test area;
wherein the processor is to receive the measured color data; and
wherein the color specific correction is applied by the processor based on the measured color data.

13. A tangible machine-readable medium comprising a set of instructions which, when executed by a processor, cause the processor to:
receive a target image defining target colors for an image to be printed;
for each pixel of the target image, determine a vector, the vector having a property representing an aspect of the color of the pixel as defined in a color space;
sorting the pixels into bins based on their associated vector properties;
defining a color having an aspect represented by a vector property associated with a highest populated bin as a dominant color of the target image; and
applying a correction to pixels of the image to be printed having a color that corresponds to the dominant color.

14. The tangible machine-readable medium according to claim 13 further comprising instructions to define a plurality of dominant colors of the target image based on the most populated bins.

15. The tangible machine-readable medium according to claim 13, wherein the instructions to apply the correction comprise instructions to:
compare a color of a pixel in the image to be printed with the dominant color to determine a difference between the color of the pixel to be printed and the dominant color;
if the difference is below a predetermined threshold, determine that the color of the pixel to be printed corresponds to the dominant color; and
reduce the difference by adjusting a color value of the pixel to be printed.
